(19) United States
(12) Patent Application Publication
(10) Pub. No.: US 2014/0180956 A1
(43) Pub. Date: Jun. 26, 2014

(54) CARRIER CAPACITY AWARE MULTI-STOP SHIPMENT GENERATOR

(71) Applicant: Oracle International Corporation, Redwood Shores, CA (US)

(72) Inventors: Sundararajan ARUNAPURAM, West Chester, PA (US); Raymond William SHAFER, Honey Brook, PA (US)

(73) Assignee: ORACLE INTERNATIONAL CORPORATION, Redwood Shores, CA (US)

(21) Appl. No.: 14/107,865

(22) Filed: Dec. 16, 2013

Related U.S. Application Data
(60) Provisional application No. 61/740,445, filed on Dec. 20, 2012.
(60) Provisional application No. 61/785,879, filed on Mar. 14, 2013.

(51) Int. Cl. G06Q 10/08

(52) U.S. Cl. CPC G06Q 10/083
USPC 705/337

(57) ABSTRACT

A method, system, and computer program product for shipment consolidation in high-performance transportation systems. The method commences upon receiving a plurality of orders to be transported from a source location to a destination location over a transportation lane, then retrieving one or more records that describe transportation carrier resource capacity covering at least a portion of the transportation lane. An enumerator facility of the method generates a plurality of candidate shipments using the transportation carrier resource capacities. Infeasible candidate shipments such as where the transportation carrier resource capacity is exceeded are eliminated, and the remaining feasible shipments are evaluated to determine a respective cost. Then the remaining shipments are ordered based at least in part on the cost, and one of the low cost feasible shipments is selected to be used for transporting the shipment.

### RELATED APPLICATIONS

The present application claims the benefit of priority to co-pending U.S. Patent Application Ser. No. 61/740,445, filed Dec. 20, 2012, entitled “SYSTEMS METHODS AND APPARATUS FOR CARRIER CAPACITY CONSIDERATIONS IN MULTISTOP SHIPMENT PLANNING” (Attorney Docket No. ORA130516-US-PSP); and the present application claims the benefit of priority to co-pending U.S. Patent Application Ser. No. 61/785,879, filed Mar. 14, 2013, entitled “SYSTEMS METHODS AND APPARATUS FOR CARRIER CAPACITY CONSIDERATIONS IN MULTISTOP SHIPMENT PLANNING” (Attorney Docket No. ORA130516-US-PSP-1), both of which are hereby incorporated by reference in their entirety.

The present application is related to co-pending U.S. patent application Ser. No. ______, entitled “FINDING MINIMUM COST TRANSPORTATION ROUTES FOR ORDERS THROUGH A TRANSPORTATION NETWORK” (Attorney Docket No. ORA130515-US-NP), filed on even date herewith, which is hereby incorporated by reference in its entirety; and the present application is related to co-pending U.S. patent application Ser. No. ______, entitled “CONCURRENT DETERMINATION OF SHIPPING MODE AND SHIP UNIT PACKING DURING TRANSPORTATION PLANNING” (Attorney Docket No. ORA130491-US-NP), filed on even date herewith, which is hereby incorporated by reference in its entirety; and the present application is related to co-pending U.S. patent application Ser. No. ______, entitled “COST AND LATENCY REDUCTIONS THROUGH DYNAMIC UPDATES OF ORDER MOVEMENT THROUGH A TRANSPORTATION NETWORK” (Attorney Docket No. ORA130492-US-NP), filed on even date herewith, which is hereby incorporated by reference in its entirety; and the present application is related to co-pending U.S. patent application Ser. No. ______, entitled “COST AND LATENCY REDUCTIONS THROUGH DYNAMIC UPDATES OF ORDER MOVEMENT THROUGH A TRANSPORTATION NETWORK” (Attorney Docket No. ORA130492-US-CIP-1), filed on even date herewith, which is hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The disclosure relates to the field of shipment consolidation and manifest shaping in high-performance transportation systems and more particularly to techniques for a carrier capacity aware multi-stop shipment generator.

### BACKGROUND

When scheduling shipment of goods from one or more source locations (e.g., from several source distribution points in a general proximity) to be shipped to one or more destination locations (e.g., to several destination points in a general proximity) it is often expeditious to put all orders destined for the one or more destination locations onto the same truck, and to then instruct the driver to make several stops in a particular order. The truck is packed so that the goods packed at the rear of the truck are unloaded at the first stop, and the goods packed at the front of the truck are unloaded at the last stop, and the other goods in the middle are similarly ordered for ease of delivery. In some cases the timing of multi-stop pickups and multi-stop deliveries are considered in the formation of the shipments.

Legacy attempts at forming such multi-stop shipments rely on a two-phase process where, in a first phase, the shipment (e.g., route and contents) is formed (e.g., to comprise all of the goods to be shipped from the one or more source locations to the destination locations). In a second phase, the already formed shipments are mapped onto available carriers for the routes.

Unfortunately, the overall success of such a legacy technique rests on the assumption that an unlimited amount of carrier capacity will be available for pick-ups and deliveries of the packed goods at the appointed times. This assumption is not always true, and becomes more frequently violated as global demand for goods increases and carriers are running at high capacity.

This situation becomes especially dire when a pre-packed shipment cannot be transported by the carriers of choice, and a second choice—and less desirable carrier—is brought in to handle the order or orders that would not fit into the actual available carrier capacity. For example, it might be discovered that the aforementioned unlimited carrier capacity assumption was wrong, and that a portion of an order that was pre-packed would not fit into the truck. That portion of the order might then need to be shipped separately, and at higher cost, or that portion of the order might then need to be shipped separately in a later, possibly delayed shipment. There is a need for an improved approach.

Moreover, none of the aforementioned technologies have the capabilities to perform the herein disclosed techniques for implementing a carrier capacity aware multi-stop shipment generator.

### SUMMARY

The present disclosure provides an improved method, system, and computer program product suited to address the aforementioned issues with legacy approaches. More specifically, the present disclosure provides a detailed description of techniques used in methods, systems, and computer program products for a carrier capacity aware multi-stop shipment generator.

The problem of high-cost order overflow handling (e.g., using a courier service to handle portions of shipments that do not fit onto a delivery truck) is solved by calculating carrier capacity before generating shipments. A carrier capacity aware multi-stop shipment generator is configured to create shipments that fit into the constraints of a carrier's equipment and networks.

Some embodiments proceed by receiving a plurality of orders to be transported from a source location to a destination location, then retrieving one or more records that describe transportation carrier resource capacity covering at least a portion of the routes from the source location to the destination location. An enumerator facility generates a plurality of candidate shipments using the transportation carrier resource capacities. Infeasible candidate shipments such as where the transportation carrier resource capacity is exceeded are eliminated, and the remaining feasible shipments are evaluated to determine a respective cost. Then the remaining shipments are ordered based at least in part on the cost, and one of the low cost feasible shipments is selected to be used for transporting the shipment.

The solution can be practiced in a system, and/or using a computer program product, and/or using a computer-implemented method. In some embodiments, a method commences upon retrieving, at a first time, transportation carrier resource capacity for a carrier, then, using the retrieved transportation carrier resource capacity, generating shipments comprising an order to be transported (e.g., shipped) by the carrier. The shipments to be transported by the carrier can comprise multi-stop shipments. The generated shipments are subjected to evaluation so as to eliminate infeasible shipments, including eliminating infeasible multi-stop shipments, and the generated shipments are stored in a database for later retrieval. For example, the generated shipments are evaluated to determine the costs of carrying a corresponding candidate shipment, and only some of the cost-determined candidate shipments are subjected to sorting operations to determine preferred candidacy (e.g., based on costs, and/or based on an under-utilization metric). Further operations map additional orders onto a preferred/selected candidate shipment.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1 is an example of a transportation system that implements a capacity aware multi-stop shipment generator, according to some embodiments.

FIG. 2A is a flow used in a pre-packed shipment mapper for comparing with flows that implement a carrier capacity aware multi-stop shipment generator.

FIG. 2B is a flow that implements a carrier capacity aware multi-stop shipment generator, according to some embodiments.

FIG. 3 is a flow diagram of a bulk planning order movement procedure as used in systems for implementing a carrier capacity aware multi-stop shipment generator, according to some embodiments.

FIG. 4 is a flow diagram of a multi-stop shipment algorithm as used in systems for implementing a carrier capacity aware multi-stop shipment generator, according to some embodiments.

FIG. 5 is a block diagram of a system for implementing a carrier capacity aware multi-stop shipment generator, according to some embodiments.

FIG. 6 depicts a block diagram of an instance of a computer system suitable for implementing an embodiment of the present disclosure.

### DETAILED DESCRIPTION

Some embodiments of the present disclosure are directed to improved approaches for implementing a carrier capacity aware multi-stop shipment generator. More particularly, disclosed herein and in the accompanying figures are exemplary environments, methods, and systems for implementing a carrier capacity aware multi-stop shipment generator.

### Overview

Legacy attempts at forming multi-stop shipments rely on a two-phase approach with underlying assumptions. In such legacy approaches, first the shipment is formed with an emphasis on packing all of the goods to be shipped from the one or more source locations to the one or more destination locations, while assuming that there is an infinite amount of carrier capacity. Then, in a second phase (a mapping phase), the legacy approaches take the already formed shipments (e.g., route and goods to be shipped) and map the shipments onto carriers. Reliance on the assumption of unlimited carrier capacity is naïve, and such a naive approach often results in a perturbation when the shipper later discovers or reports that the carrier does not possess unlimited capacity (i.e., as was built into the assumptions of the mapping phase).

The improvements disclosed herein improve the overall performance of the shipping activities by replacing the erroneous assumption of unlimited carrier capacity with carrier capacity awareness during the shipment generation process.

### DEFINITIONS

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### DESCRIPTIONS OF EXEMPLARY EMBODIMENTS

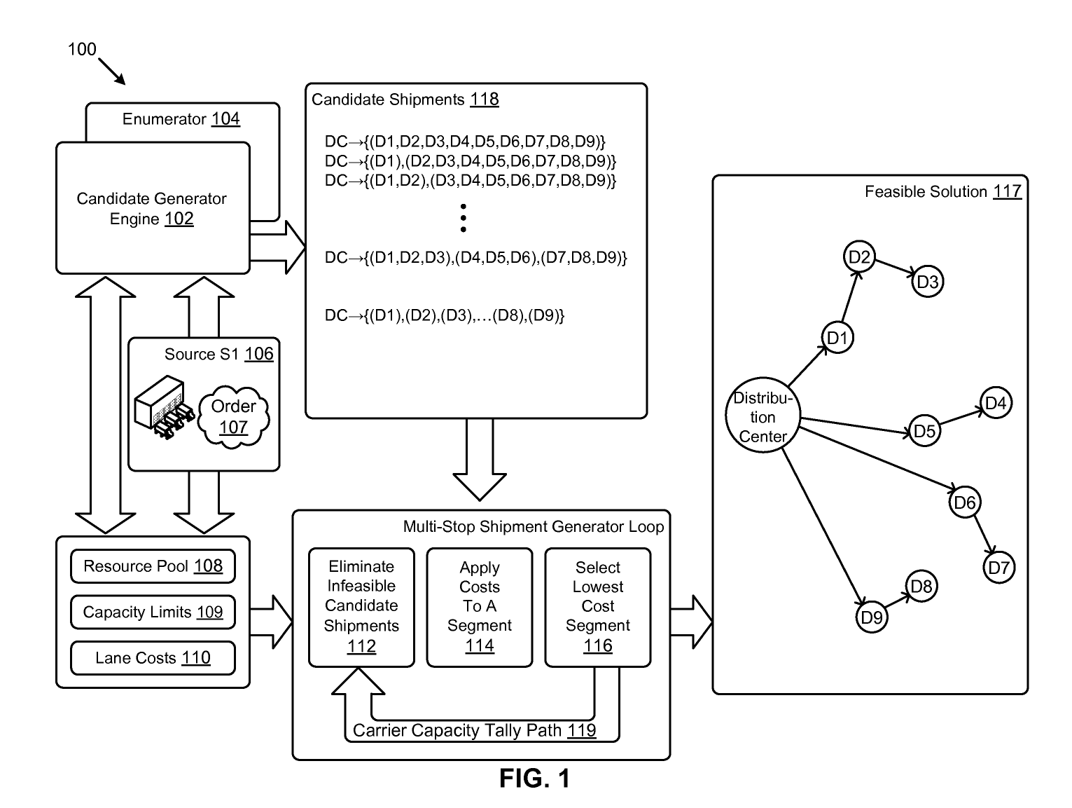

FIG. 1 is an example of a transportation system 100 for implementing multi-stop shipments using a carrier capacity aware multi-stop shipment generator. As an option, the present transportation system 100 or any aspect thereof may be implemented in the context of the architecture and functionality of the embodiments described herein. Also, the transportation system 100 or any aspect thereof may be implemented in any desired environment.

As shown, orders (e.g., one or more orders comprising goods such as order 107) are made available for shipment at a source location (e.g., source location S1 106). Upon examination of the order, the components of the order have various different destination locations (e.g., destination D1, destination D2, destination D3, destination D4, destination D5, . . . destination D9), and the various destinations may be proximally located so as to facilitate shipment of the individual components of the order in (for example) one truck that makes many stops (e.g., a multi-stop shipment).

The configuration of the shipment (e.g., a single multi-stop shipment) or shipments (e.g., multiple shipments involving multiple segments) may depend on many factors, including proximity between stops, total duration of the end-to-end sequence of stops, costs incurred, interstate commerce rules or limitations, availability of equipment, availability of drivers corresponding to the equipment, and so on. In a computer-aided situation, it is often reasonable to enumerate all possible configurations of a shipment or multiple shipments. In the example given in FIG. 1, some of the possible configurations are listed in a notational syntax that encloses a shipment of the entire order within braces, and encloses a stop within matching parentheses. Table 1 further describes this notation for syntax and semantics.

TABLE 1
Notation

| Syntax | Meaning |
|---|---|
| DC→{(D1,D2,D3,D4, | Pickup at location DC (distribution center) |
| D5,D6,D7,D8,D9)} | and deliver to D1-D9 using a single multi-stop |
| | shipment |
| DC→{(D1,D2,D3),(D4, | Pickup at location DC and deliver to D1-D9 |
| D5, D6),(D7,D8,D9)} | using a first multi-stop shipment to D1, D2, |
| | and D3), and a second multi-stop shipment to |
| | D4, D5, and D6), and a third multi-stop |
| | shipment to (D7, D8, and D9) |
| DC→{(D1),(D2),(D3),... | Pickup at location DC and deliver individual |
| (D8),(D9)} | shipments, each having a single leg from DC |
| | to Dn |

A complete enumeration of all possible configurations of a shipment or multiple shipments can be accomplished by an enumerator 104. The possible configurations can then be evaluated to eliminate infeasible shipments (see operation 112), apply costs to the remaining feasible shipments (see operation 114), and select a lowest cost shipment (see operation 116). As earlier indicated the feasibility may depend on many variables or conditions, including resources. Accordingly, the evaluation to eliminate infeasible shipments may include inputs in the form of a description of available resources (e.g., see resource pool 108, and capacity limits 109). The resources used in forming a shipment can be tallied such that they are not used again in determining feasibility. For example, if a resource (e.g., a truck) representing some aspect of a transportation carrier's capacity (e.g., a fleet of trucks) is used for the purpose of delivering order components to (D1, D2, D3), then it cannot be concurrently used for the purpose of delivering order components to (D8, D9).

The aforementioned technique involving enumerating the possible shipments is merely one technique. Other techniques possess different characteristics. For example, a shipment generator (e.g., candidate generator engine 102) might generate candidate shipments 118 based on predefined transportation lanes, or might prune redundant or infeasible shipments even before being subjected to the elimination processing of operation 112. Or, a candidate generator engine 102 might generate candidate shipments 118 using a technique of construction where (for example) a shipment only becomes listed among the candidate shipments 118 if it can be shown to have some savings over one or more previously generated candidate shipment configurations. In the illustrative example shown, a candidate generator engine 102 can access resource availability, capacity limits, and cost data (e.g., see resource pool 108 and transportation lane costs 110).

The operation to eliminate infeasible shipments (see operation 112) can, for example, access carrier capacity limits. Consider a sample order (e.g., order 107) having a total of nine units each weighing 15,000 pounds, and one unit is to be delivered to each of destinations D1, D2, D3, D4, D5, D6, D7, D8, and D9. Also consider that the resource pool lists large trucks (capable of carrying up to 45,000 pounds), and small trucks (capable of carrying up to 30,000 pounds). In this scenario having an unspecified (e.g., unlimited) number of large trucks and small trucks, one solution might be to process the order in three shipments, each shipment having three stops. For example, {(D1, D2, D3), (D4, D5, D6), and (D7, D8, D9)}.

Now, further consider a resource constraint such that rather than an unlimited number of trucks, there are only exactly three small trucks, and only exactly one large truck. Such a constraint would mean that there can be at most one shipment of 45,000 pounds.

Strictly as an illustrative example, Table 2 depicts evaluation of candidate shipments.

TABLE 2
Evaluation of candidate shipments

| Syntax | Meaning |
|---|---|
| DC→(D1, D2, | Pick up at location DC with a large truck and deliver to |
| D3) | locations D1, D2, and D3 using a three stop multi-stop |
| | shipment (maximum weight of 45,000 pounds) |
| DC→(D4, D5) | Pick up at location DC with a small truck and deliver to |
| | locations D4 and D5 using a two-stop multi-stop |
| | shipment (maximum weight of 30,000 pounds) |
| DC→(D6, D7) | Pick up at location DC with a small truck and deliver to |
| | locations D6 and D7 using a two-stop multi-stop |
| | shipment (maximum weight of 30,000 pounds) |
| DC→(D8, D9) | Pick up at location DC with a small truck and deliver to |
| | locations D8 and D9 using a two-stop multi-stop |
| | shipment (maximum weight of 30,000 pounds) |

Thus, one possible solution can be noted as: {(D1, D2, D3), (D4, D5), (D6, D7), D8, D9)}.

Still further constraints may be considered when finding solutions (e.g., lowest cost solutions). For example, the operation to eliminate infeasible shipments might consider only accepted transportation lanes, which can be retrieved from or inferred from transportation lane costs 110. Or, the operation to apply costs 114 might consider transportation lane costs 110, and might generate a candidate shipment noted as {(D5, D4)}, which might be generated instead of {(D4, D5)}. Or, the operation to apply costs 114 might consider transportation lane costs 110, and might generate a candidate shipment noted as {(D9, D8)}, which might be generated instead of {(D8, D9)}.

Continuing the example of FIG. 1, one solution that does not violate the example constraints can be noted as: {(D1, D2, D3), (D5, D4), (D6, D7), (D9, D8)}, shown graphically as feasible solution 117. In the event that such a solution were deemed to be the selected solution, then the consumed resources would be tallied (e.g., to prevent reuse), possibly using a construction such as a carrier capacity and resource usage tally path 119.

The foregoing list contains certain availabilities, configurations, constraints and costs. Other availabilities, configurations, constraints and costs are possible, some of which constraints are disclosed hereunder in Table 3.

TABLE 3
Example availabilities, configurations, constraints and costs

| Name | Comment |
|---|---|
| CAPACITY_USAGE | Holds a value of the amount of carrier capacity |
| | used |
| EQUIPMENT_TYPE | Name of a particular type of equipment, possibly |
| | annotated with an attribute schedule |
| LANE | Name of a transportation lane, possibly annotated |
| | with a cost schedule |
| LIMIT | Total number of available resources of a |
| | particular EQUIPMENT_TYPE |
| USAGE | Usage tally |

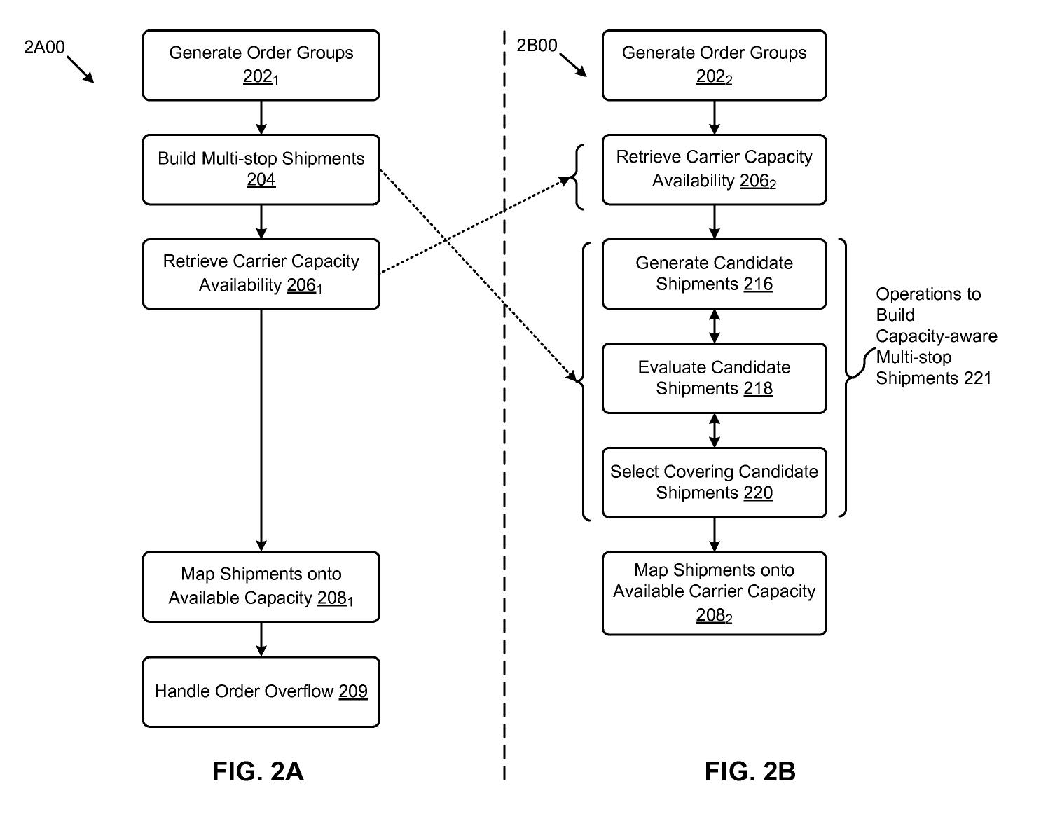

FIG. 2A is a flow used in a pre-packed shipment mapper 2A00 for comparing with flows that implement a carrier capacity aware multi-stop shipment generator. As an option, the present pre-packed shipment mapper 2A00 or any aspect thereof may be implemented in the context of the architecture and functionality of the embodiments described herein. Also, the pre-packed shipment mapper 2A00 or any aspect thereof may be implemented in any desired environment.

As shown, prepacked shipment mapper 2A00 builds shipments (see the operation to build multi-stop shipments 204) and then maps the prepacked shipments onto available capacity (see operation 208₁). In some cases, the operation to build multi-stop shipments 204 may receive inputs in the form of generated order groups (see operation 202₁). Order groups can be generated using any known techniques. The prepacked shipment mapper 2A00 can build feasible shipments, including multi-stop shipments. Additional awareness of carrier capacity can lead to different feasible shipments, and in some cases can lead to lower cost shipments. In particular, in the event that less than 100% of an order can be mapped onto a particular carrier's available capacity—leaving some order overflow—it might be that an alternative and possibly less preferred (e.g., higher cost) carrier is called in to handle the order overflow. Additional awareness of carrier capacity can lead to consideration of feasible shipments that stay within the constraints of the carrier's available capacity and thus avoid any order overflow (see operation to handle order overflow 209).

One way to accomplish this is to perform the step to retrieve carrier capacity availability earlier in the flow. For example, the step to retrieve carrier capacity availability 206₁ of FIG. 2A might be cast as a different instance of a step to retrieve carrier capacity availability 206₂ of FIG. 2B, which is presently discussed.

FIG. 2B is a flow 2B00 that implements a carrier capacity aware multi-stop shipment generator. As an option, the present flow 2B00 or any aspect thereof may be implemented in the context of the architecture and functionality of the embodiments described herein. Also, the flow 2B00 or any aspect thereof may be implemented in any desired environment.

As mentioned in the foregoing discussion of FIG. 2A, one way to accomplish additional awareness of carrier capacity that can lead to desired results is to perform the step to retrieve carrier capacity availability earlier in the flow, specifically, before operations to generate candidate shipments. One possible flow implements a carrier capacity aware multi-stop shipment generator that commences by generating order groups (see operation 202₂) which order groups are provided as inputs to an operation to retrieve carrier capacity availability 206₂, which is then followed by operations to build multi-stop shipments.

In the embodiment of FIG. 2B, the steps to build multi-stop shipments include operations to generate candidate shipments 216, operations to evaluate candidate shipments 218, and operations to select covering candidate shipments 220. When the carrier capacity aware multi-stop shipments are built, then since the multi-stop shipments are built with carrier capacity awareness, the flow 2B00 serves to generate carrier capacity aware multi-stop shipments that do not result in order overflow, and the generate carrier capacity aware multi-stop shipments are mapped onto available carrier capacity (see operation 208₂), which carrier capacity has already been retrieved (see operation to retrieve carrier capacity availability 206₂) and used in the operations to build capacity-aware multi-stop shipments 221.

Referring to the aforementioned operations to build multi-stop shipments 221, and more specifically to the operations to generate candidate shipments 216, candidate shipments can be formed using the concept of a sequence (e.g., a sequence of stops) in conjunction with the concept of a transportation lane. Strictly as an example, a sequence can be constructed beginning from a set of sequences corresponding to transportation lanes for moving goods from the source location(s) to the destination location(s). A non-multipoint sequence (e.g., from source location 51 to destination location D1) can be used as a first transportation lane, and other destination locations can be added to the first transportation lane to create a two-stop shipment, and then an additional destination location can be added to create a three-stop shipment and so on, while evaluating the effect of adding the shipment, (in particular, observing any carrier capacity constraints as pertaining to the carrier capacity availability) that had been retrieved (see operation to retrieve carrier capacity availability 206₂).

In addition to observing any carrier capacity constraints, the effect of adding a stop to a multi-stop sequence can be evaluated (see operation to evaluate candidate shipments 218), and that evaluation can include many considerations that can be evaluated to a score or a cost or a savings. If the effect of adding a candidate stop to a multi-stop sequence does not have the potential to generate a savings, then the candidate stop is discarded. In some embodiments, the number of candidate stops might be large, and the interaction between the operation to generate candidate shipments 216 and the operation to evaluate candidate shipments 218 might be carried out with high frequency.

Given the multi-stop shipments that are mapped onto available carrier capacity (see operation 208₂), in some cases, operation 208₂ further serves to arrange a stop sequence that accords to certain objective functions (e.g., to generate a given stop sequence used in further processing). For example, a multi-stop sequence including a pickup at a source point, followed by stops at a location corresponding to destination location D4 and destination location D5 might be sequenced as a stop at a location corresponding to destination D5 followed by a stop at destination D4.

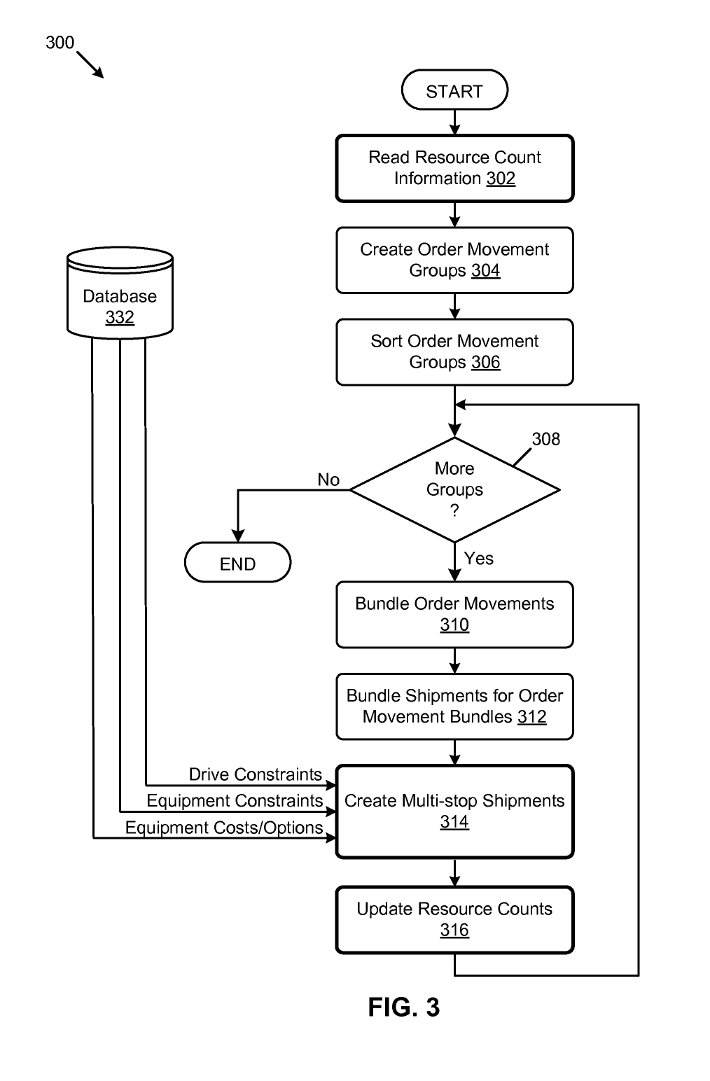

FIG. 3 is a flow diagram of a bulk planning order movement procedure 300 as used in systems for implementing a carrier capacity aware multi-stop shipment generator. As an option, the present bulk planning order movement procedure 300 or any aspect thereof may be implemented in the context of the architecture and functionality of the embodiments described herein. Also, the bulk planning order movement procedure 300 or any aspect thereof may be implemented in any desired environment.

The techniques for generating carrier capacity aware multi-stop shipments can be used in the context of systems implementing bulk planning and in systems that generate order movements. For example, the operation to create multi-stop shipments 314 as depicted in the flow diagram of bulk planning order movement procedure 300 can be employed in a loop for processing order movement groups (e.g., see loop decision 308). More specifically, a bulk planning order movement procedure 300 can include operations to read resource count information (see operation 302), operations to create multi-stop shipments, and operations to update resource counts (see operation to update resource counts 316). In this manner a large group of orders can be mapped onto available carrier capacity without overflow.

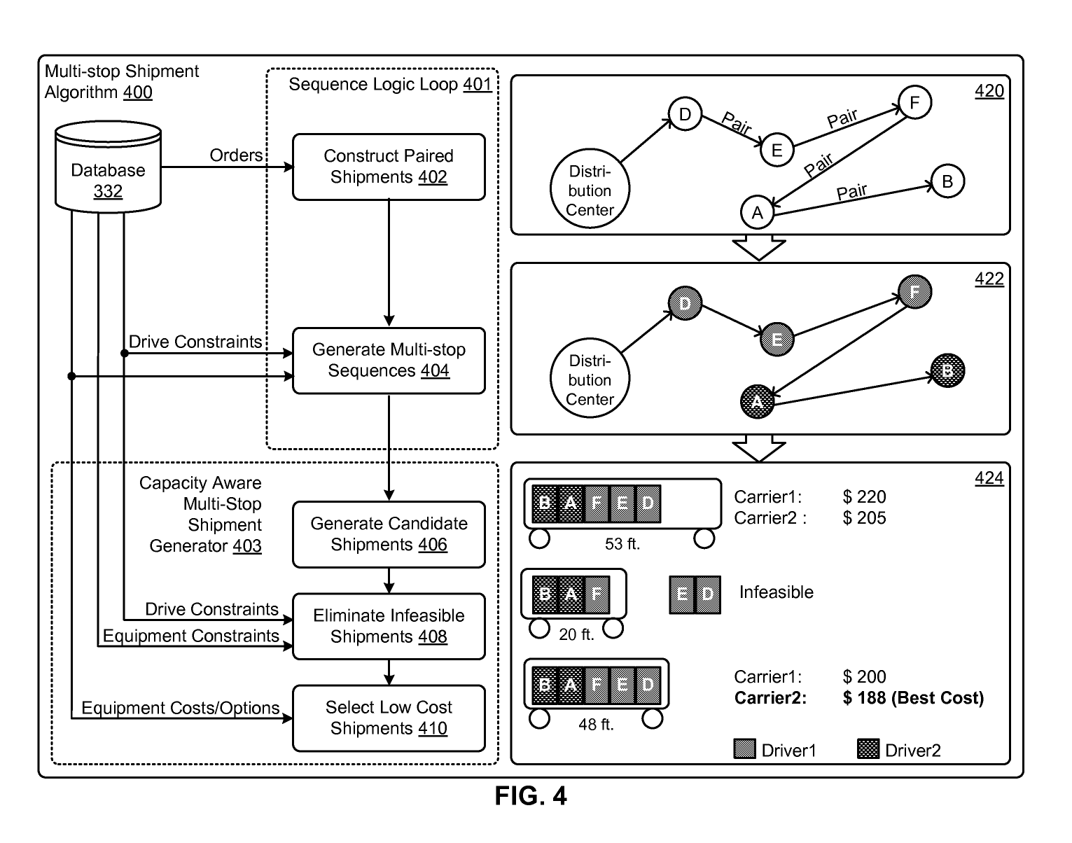

Continuing with the description of bulk planning order movement procedure 300, many orders can become candidates to arrange into order movement groups (see operation 304), and such groups might be formed based on characteristics of the source location regions and/or destination location regions of respective orders. Or, such groups might be formed based on characteristics of the source location and/or destination location defining a sequence that is subsumed by another order group, which conditions might facilitate packing into the same shipping unit or might facilitate packing into the same truck. Further, the formed order groups can be sorted (see operation 306) or otherwise organized such that order groups can be formed and packed to facilitate a multi-stop regime. Some examples are given in FIG. 4, which is discussed infra.

When the order movement groups are defined, processing iterates over the order movement groups in order to bundle order movements (see operation 310), bundle shipments by mapping individual shipments onto order movement bundles (see operation 312), then create multi-stop shipments (see operation to create multi-stop shipments 314).

As is now understood, while generating carrier capacity aware multi-stop shipments, capacity is consumed as resources are assigned. Accordingly, the flow of bulk planning order movement procedure 300 includes operations to update resource counts 316 before looping back to iterate over another order movement group.

FIG. 4 is a flow diagram of a multi-stop shipment algorithm 400 as used in systems for implementing a carrier capacity aware multi-stop shipment generator. As an option, the present multi-stop shipment algorithm 400 or any aspect thereof may be implemented in the context of the architecture and functionality of the embodiments described herein. Also, the multi-stop shipment algorithm 400 or any aspect thereof may be implemented in any desired environment.

As shown, the multi-stop shipment algorithm employs a series of operations that access a database 332. The database 332 holds orders, various constraints, and various shipping options. In this embodiment, orders are initially accessed by an operation to construct paired stops (see operation 402), which paired stops can be sequenced in order to minimize costs or distances, or drive times or other objectives, and/or to generate multi-stop sequences that do not violate constraints. In some implementations, operation 402 and operation 404 can be organized into a loop (e.g., sequence logic loop 401) which can loop or otherwise iterate over any number of orders. Strictly as an example, possibilities of objectives to minimize, and/or constraints to be met, are encompassed in the shown drive constraints. Another possibility includes equipment constraints. Table 4 lists some sample drive constraints.

TABLE 4
Sample drive constraints

| Constraint | |
|---|---|
| Name | Constraint Description |
| Hours of | Hours of Service such as total number of shift hours that a |
| Service | driver can operate equipment during a day (e.g., as per |
| | Department of Transportation or other rule-making authority) |
| Location | Dates of operation, and/or blackout dates for a respective |
| Calendars | location |
| Pick-up | Times when deliveries can be picked-up from a respective |
| Windows | location |
| Drop-off | Times when deliveries can be dropped-off at a respective |
| Windows | location |

Example results of the operation to construct paired stops are shown in the five-stop shipment 420, which shows movement from a distribution center to destination D, then to destination E, then to destination F, then to destination A, and to destination B. Further, the results of the operation to generate multi-stop sequences are shown in the five-stop multi-stop sequence 422, which shows movement from a distribution center to destination D, then to destination E, then to destination F using a first driver (depicted as Driver1) and then to destination A and to destination B using a second driver (depicted as Driver2). Such a multi-stop sequence (e.g., as shown in the five-stop multi-stop sequence 422) serves as input to further processing to generate multi-stop shipments using the carrier capacity aware multi-stop shipment generator 403. The operations in this partition implement operations to generate candidate shipments 406, eliminate infeasible shipments 408, and select low cost shipments 410. The database 332 can be accessed to retrieve drive constraints, equipment constraints, and equipment costs/options. Schematic 424 shows an example generated shipment and pricing (e.g., the 53 ft. truck), some example infeasible shipments (e.g., the 20 ft. truck), and a particular selected low cost option (e.g., the 48 ft. truck). The feasible options are depicted with pricing and a low cost option is selected (see the 48 ft. option using carrier “Carrier2”), which selected low cost option becomes the subject of downstream processing.

### ADDITIONAL EMBODIMENTS OF THE DISCLOSURE

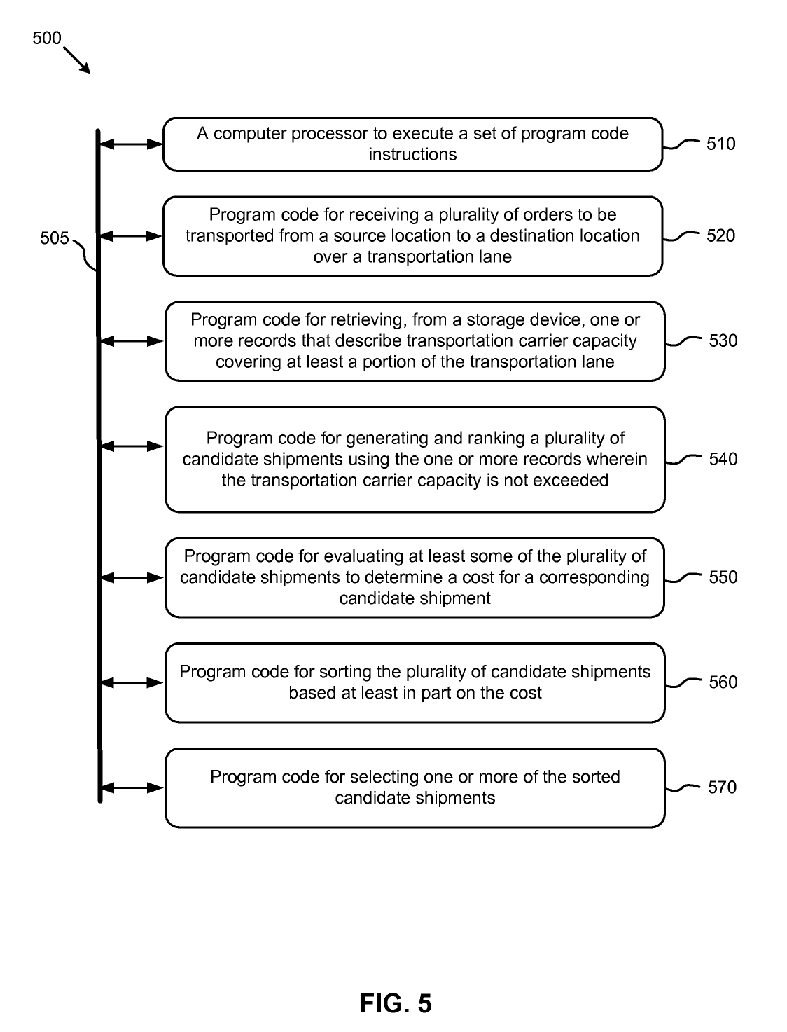

FIG. 5 is a block diagram of a system for implementing a carrier capacity aware multi-stop shipment generator, according to some embodiments. As an option, the present system 500 may be implemented in the context of the architecture and functionality of the embodiments described herein. Of course, however, the system 500 or any operation therein may be carried out in any desired environment.

As shown, system 500 comprises at least one processor and at least one memory, the memory serving to store program instructions corresponding to the operations of the system. As shown, an operation can be implemented in whole or in part using program instructions accessible by a module. The modules are connected to a communication path 505, and any operation can communicate with other operations over communication path 505. The modules of the system can, individually or in combination, perform method operations within system 500. Any operations performed within system 500 may be performed in any order unless as may be specified in the claims. The embodiment of FIG. 5 implements a portion of a computer system, shown as system 500, comprising a computer processor to execute a set of program code instructions (see module 510) and modules for accessing memory to hold program code instructions to perform: receiving a plurality of orders to be transported from a source location to a destination location over a transportation lane (see module 520); retrieving, from a storage device (e.g., a disk drive), one or more records that describe transportation carrier capacity covering at least a portion of the transportation lane (see module 530); generating and ranking (e.g., by percentage or extent of under-utilization) a plurality of candidate shipments using the one or more records wherein the transportation carrier capacity is not exceeded (see module 540); evaluating at least some of the plurality of candidate shipments to determine a cost for a corresponding candidate shipment (see module 550); sorting the plurality of candidate shipments based at least in part on the cost (see module 560); and selecting one or more of the sorted candidate shipments (see module 570).

The system 500 can be employed to implement steps for retrieving, at a first time, transportation carrier capacity for a carrier, and then (e.g., at a second time), the retrieved transportation carrier capacity to generate data records describing shipments to be transported by the carrier; wherein the second time is later than the first time.

### System Architecture Overview

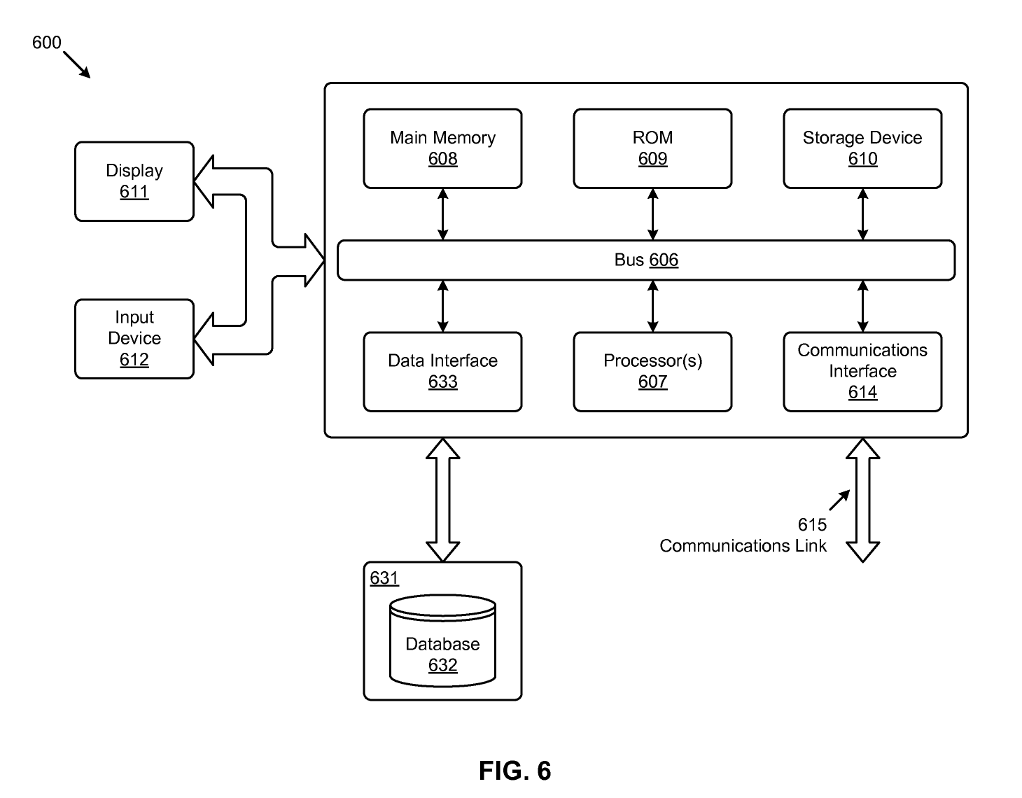

FIG. 6 depicts a block diagram of an instance of a computer system 600 suitable for implementing an embodiment of the present disclosure. Computer system 600 includes a bus 606 or other communication mechanism for communicating information, which interconnects subsystems and devices, such as a processor 607, a system memory 608 (e.g., RAM), a static storage device (e.g., ROM 609), a disk drive 610 (e.g., magnetic or optical), a data interface 633, a communication interface 614 (e.g., modem or Ethernet card), a display 611 (e.g., CRT or LCD), input devices 612 (e.g., keyboard, cursor control), and an external data repository 631.

According to one embodiment of the disclosure, computer system 600 performs specific operations by processor 607 executing one or more sequences of one or more instructions contained in system memory 608. Such instructions may be read into system memory 608 from another computer readable/usable medium, such as a static storage device or a disk drive 610. In alternative embodiments, hard-wired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to processor 607 for execution. Such a medium may take many forms, including but not limited to, non-volatile media and volatile media. Non-volatile media includes, for example, optical or magnetic disks, such as disk drive 610. Volatile media includes dynamic memory, such as system memory 608.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of the computer system 600. According to certain embodiments of the disclosure, two or more computer systems 600 coupled by a communications link 615 (e.g., LAN, PTSN, or wireless network) may perform the sequence of instructions required to practice the disclosure in coordination with one another.

Computer system 600 may transmit and receive messages, data, and instructions, including programs (e.g., application code), through communications link 615 and communication interface 614. Received program code may be executed by processor 607 as it is received, and/or stored in disk drive 610 or other non-volatile storage for later execution. Computer system 600 may communicate through a data interface 633 to a database 632 on an external data repository 631. A module as used herein can be implemented using any mix of any portions of the system memory 608, and any extent of hard-wired circuitry including hard-wired circuitry embodied as a processor 607.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than restrictive sense.

What is claimed is:

1. A computer implemented method comprising:
using a computing system having at least one processor to perform a process, the process comprising:
receiving a plurality of orders to be transported from a source location to a destination location;
retrieving one or more records that describe transportation carrier resource capacity pertaining to single or multi-stop transport of the plurality of orders from the source location to the destination location;
generating a plurality of candidate shipments using the one or more records that describe transportation carrier resource capacity, wherein the transportation carrier resource capacity is not exceeded;
evaluating at least some of the plurality of candidate shipments to determine a cost for a corresponding candidate shipment; and
selecting one or more of the candidate shipments wherein the selection is based at least in part on the cost.

2. The method of claim 1, wherein the plurality of candidate shipments comprise multi-stop shipments.

3. The method of claim 2, wherein the multi-stop shipments comprise a given stop sequence.

4. The method of claim 1, further comprising evaluating at least some of the plurality of candidate shipments to determine a set of infeasible shipments.

5. The method of claim 4, further comprising eliminating at least some of the plurality of candidate shipments based at least in part on the set of infeasible shipments.

6. The method of claim 1, further comprising evaluating at least some of the plurality of candidate shipments to determine an under-utilization metric for a corresponding candidate shipment.

7. The method of claim 1, further comprising mapping additional orders onto a selected candidate shipment.

8. The method of claim 1, further comprising sorting the plurality of candidate shipments based at least in part on the cost.

9. The method of claim 1, further comprising sorting the plurality of candidate shipments based at least in part on an under-utilization metric.

10. The method of claim 1, further comprising marking consumed portions of the transportation carrier resource capacity to prevent reuse.

11. A computer program product embodied in a non-transitory computer readable medium, the computer readable medium having stored thereon a sequence of instructions which, when executed by a processor causes the processor to execute a process, the process comprising:
receiving a plurality of orders to be transported from a source location to a destination location;
retrieving one or more records that describe transportation carrier resource capacity pertaining to single or multi-stop transport of the plurality of orders from the source location to the destination location;
generating a plurality of candidate shipments using the one or more records that describe transportation carrier resource capacity, wherein the transportation carrier resource capacity is not exceeded;
evaluating at least some of the plurality of candidate shipments to determine a cost for a corresponding candidate shipment; and
selecting one or more of the candidate shipments wherein the selection is based at least in part on the cost.

12. The computer program product of claim 11, wherein the plurality of candidate shipments comprise multi-stop shipments.

13. The computer program product of claim 12, wherein the multi-stop shipments comprise a given stop sequence.

14. The computer program product of claim 11, further comprising instructions for evaluating at least some of the plurality of candidate shipments to determine a set of infeasible shipments.

15. The computer program product of claim 14, further comprising instructions for eliminating at least some of the plurality of candidate shipments based at least in part on the set of infeasible shipments.

16. The computer program product of claim 11, further comprising instructions for evaluating at least some of the plurality of candidate shipments to determine an under-utilization metric for a corresponding candidate shipment.

17. The computer program product of claim 11, further comprising instructions for mapping additional orders onto a selected candidate shipment.

18. The computer program product of claim 11, further comprising instructions for sorting the plurality of candidate shipments based at least in part on the cost.

19. A computer system comprising:
a generator module configured to generate a plurality of candidate shipments using one or more records that describe transportation carrier resource capacity, wherein the transportation carrier resource capacity is not exceeded;
an evaluator module to determine a cost for respective candidate shipments; and
a selector module to select one or more of the candidate shipments wherein the selection is based at least in part on the cost.

20. The computer system of claim 19, wherein the generator module is configured to build multi-stop shipments.
